(19) United States
(12) Patent Application Publication
(10) Pub. No.: US 2025/0134085 A1
(43) Pub. Date: May 1, 2025

(54) Insect Trap

(71) Applicant: Clifford Warren Davis, JR., Fairhope, AL (US)

(72) Inventor: Clifford Warren Davis, JR., Fairhope, AL (US)

(21) Appl. No.: 18/933,877

(22) Filed: Oct. 31, 2024

Related U.S. Application Data
(60) Provisional application No. 63/546,537, filed on Oct. 31, 2023.

(51) Int. Cl. A01M 1/14; A01M 1/10; A01M 1/24

(52) U.S. Cl. CPC A01M 1/14; A01M 1/106; A01M 1/24

(57) ABSTRACT

The present disclosure provides an improved insect trap. In particular, the insect trap disclosed herein is especially useful for trapping tunneling or boring insects such as carpenter bees, or bees in the genus Xylocopa. The improved insect trap covers a carpenter bee bore and can trap the carpenter bees in the improved insect trap when the carpenter bees attempt to fly out.

### CROSS-REFERENCE TO RELATED APPLICATION

This application claims the benefit of, and priority to, pending U.S. Provisional Patent Application No. 63/546,537, filed Oct. 31, 2023, which is incorporated by reference herein in its entirety.

### FIELD OF INVENTION

This invention relates generally to insect traps and, more particularly, to a trap for carpenter bees.

### BACKGROUND OF THE INVENTION

Carpenter bees are a problem in certain geographical regions because they tend to bore holes in various wooden structures, including houses, fences or decks. Once the bees penetrate the wooden facade of a house, they can spread through the interior of the house, becoming a nuisance and causing physical damage. Thus, there is a need for a trap for these pests in the vicinity of wooden structures to be protected from them. It is a primary object of the present invention to provide such a trap which is effective in trapping carpenter bees and address the failings of the prior art traps.

### SUMMARY OF THE PRIOR ART

Few insect traps are tailored to controlling carpenter bees. An example of this kind of trap is disclosed by application Ser. No. 14/625,478. The trap consists of an entrance unit with a receptacle, where the entrance hole slopes upwards. The trap entrance variations are all cumbersome because they each artificially create new nest entrances, and do not use existing carpenter bee bores. Further, the one mention of injecting an existing carpenter bee bore with insecticide does not mention the use of a trap.

### BRIEF SUMMARY OF THE INVENTION

The improved insect trap 10's objective is to trap boring or tunneling insects, such as carpenter bees, or bees in the genus Xylocopa. The improved insect trap 10 may be placed over a bore of a substrate to trap insects. Insects, such as carpenter bees, are attracted to light; therefore, will fly from a bore into the improved insect trap 10.

In an aspect described herein, a device for trapping insects, the improved insect trap 10, is disclosed. The improved insect trap 10 may have a cylindrical-shaped funnel with opposing exits, a funnel extension, ball and socket joints, attachments including apertures, a cylindrical-shaped hollow cap adapter, threads or other means, and a catch basin. The cylindrical-shaped funnel, funnel extension, and the cylindrical-shaped hollow cap adapter may be connected by ball and socket joints. The attachments may connect the funnel to a substrate. The cylindrical-shaped hollow cap adapter may connect to a catch basin through threads or other means.

In another aspect described herein, the improved insect trap 10 may also include a cylindrical-shaped hollow cap, a sliding door, a catch basin, and threading or other means. The improved insect trap 10 may have the cylindrical-shaped hollow cap with a hollow cylinder inside with threads or other means to fasten the catch basin or cylindrical-shaped hollow cap adapter. The cylindrical-shaped hollow cap may have threads or other means to fasten the catch basin.

In another aspect described herein, a sliding door may be attached to open and close any portion of the passageway through the funneling element 12: the cylindrical-shaped funnel, funnel extension, cylindrical-shaped hollow cap adapter, or the cylindrical-shaped hollow cap.

In another aspect described herein, the insect trap 10 wherein may also include a catch basin that is disposable, clear, translucent, temporary, have handles, adhesives, filled dark circles, and threading or other means. These catch basins may be attached to either the cylindrical-shaped hollow cap adapter or the cylindrical-shaped hollow cap by threading or other means.

### BRIEF DESCRIPTION OF THE DRAWINGS

To further illustrate the advantages and features of the present disclosure, a more particular description of the invention will be rendered by reference to specific embodiments thereof which are illustrated in the appended drawings. It is appreciated that these drawings are not to be considered limiting in scope. The invention will be described and explained with additional specificity and detail through the use of the accompanying drawings in which:

FIG. 1 shows one embodiment of the insect trap disclosed herein.

FIG. 2 shows another view of the insect trap of FIG. 1.

FIG. 3 shows one embodiment of the funneling element of the cylindrical-shaped hollow cap of the insect trap disclosed herein.

FIG. 4 shows one embodiment of the cap attachment means of the cylindrical-shaped hollow cap of the insect trap disclosed herein.

FIG. 5 shows one embodiment of the catch basin of the insect trap disclosed herein.

### DETAILED DESCRIPTION

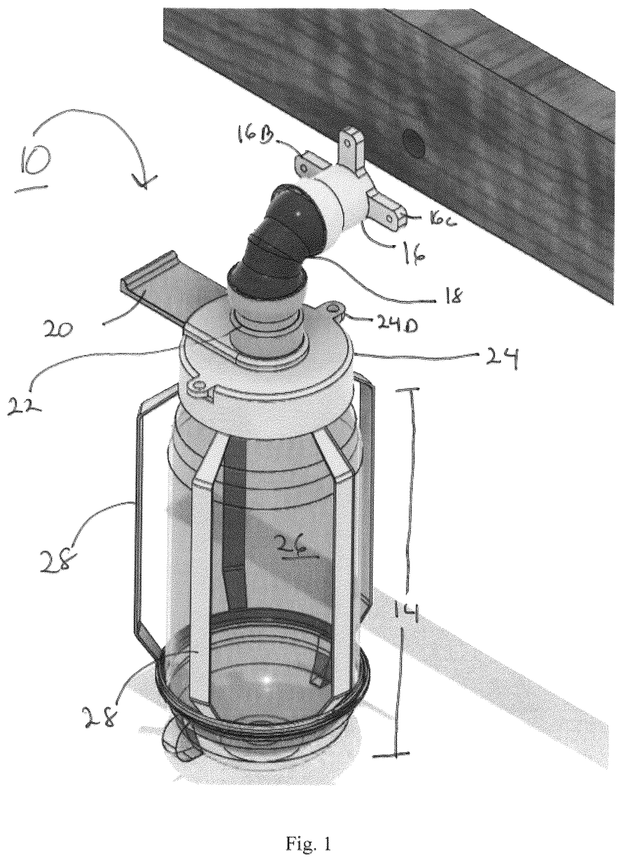

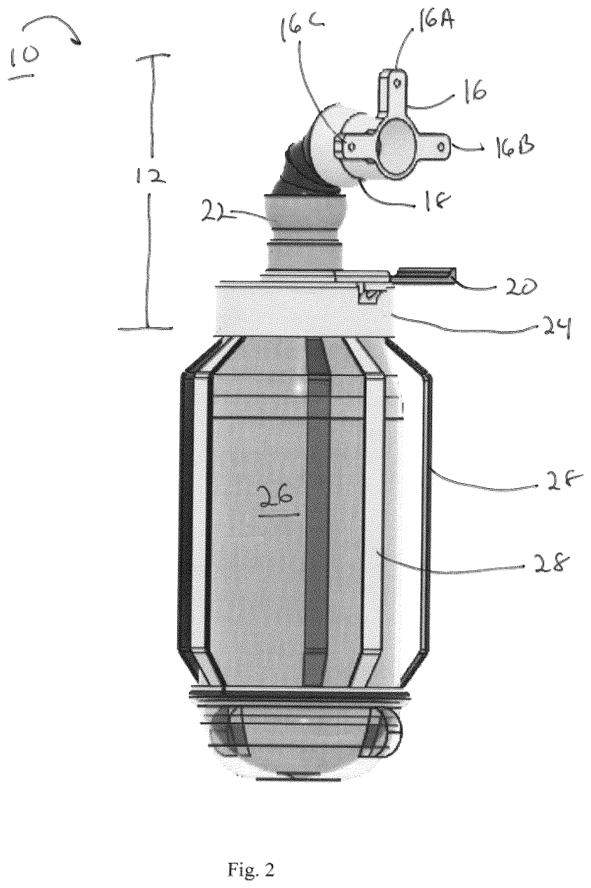

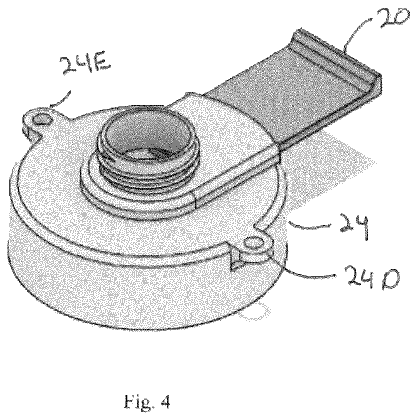

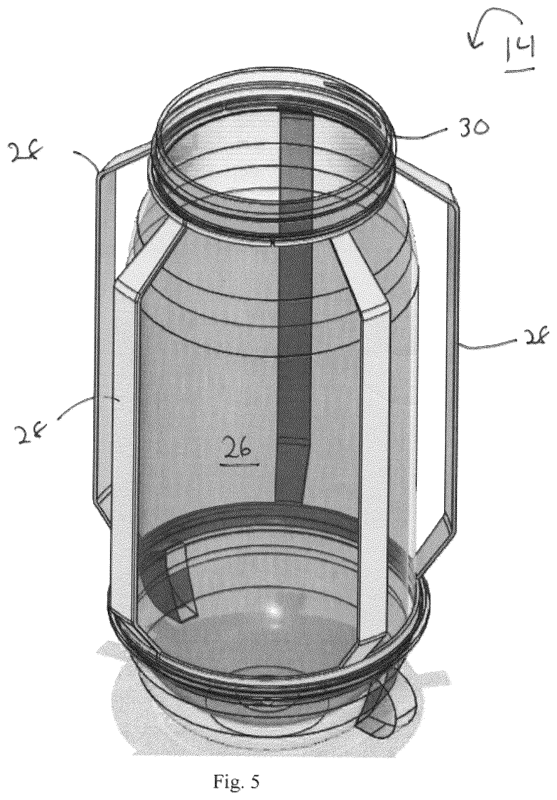

The present disclosure provides an improved insect trap 10. In particular the insect trap 10 disclosed herein is especially useful for trapping tunneling or boring insects such as carpenter bees, or bees in the genus Xylocopa. Now referring to FIGS. 1-5, the insect trap 10 includes a funneling element 12 and a catch basin 14.

The funneling element 12 includes cylindrical-shaped funnel 16 with attachment means 16A, 16B and 16C, funnel extension 18, sliding door 20 and cylindrical-shaped hollow cap adapter 22 and cylindrical-shaped hollow cap 24.

In one preferred embodiment, insect trap 10 is adapted/configured to be placed over an active tunnel or bore made by a carpenter bee. For example, in FIG. 1 this placement is shown over the bore (not labelled) on the wooden piece (not labelled). After the insect trap 10 is placed over the bore, the attachment means 16A, 16B and 16C can be used to attach the insect trap 10 to a substrate (such as the wooden piece of FIG. 1 in which the bore is made). In the embodiment shown in FIG. 1, the attachment means 16A, 16B and 16C contain apertures through which a screw or other fastener can be placed. In one preferred embodiment, the insect trap 10 is then reversibly attached to the substrate (such as the wooden piece) over the bore via the fasteners.

It is believed that any live insect, such as a carpenter bee, would exit its bore eventually and enter the funnel 16. In the embodiment where the insect is a carpenter bee, it is known that carpenter bees are attracted to light, thus the bee will continue through the funneling element 12 and into the catch basin 14 which is clear or translucent. In doing so, the carpenter bee will proceed through funnel 16 and the funnel extension 18. Next the carpenter bee will pass the sliding door 20, the cap adapter 22 and the cap 24 before entering the catch basin 14.

In one embodiment, the funnel extension 18 is flexible and allows a user to more easily maneuver the insect trap 10 into position for use. The cylindrical-shaped hollow cap adapter 22 receives and secures the cylindrical-shaped hollow cap 24 in the embodiment shown in the figures hereto. In an alternate embodiment, the cylindrical-shaped hollow cap adapter 22 can directly receive and secure the catch basin 14. This is particularly useful in the embodiment where the catch basin 14 is merely a disposable bottle (such as a water bottle).

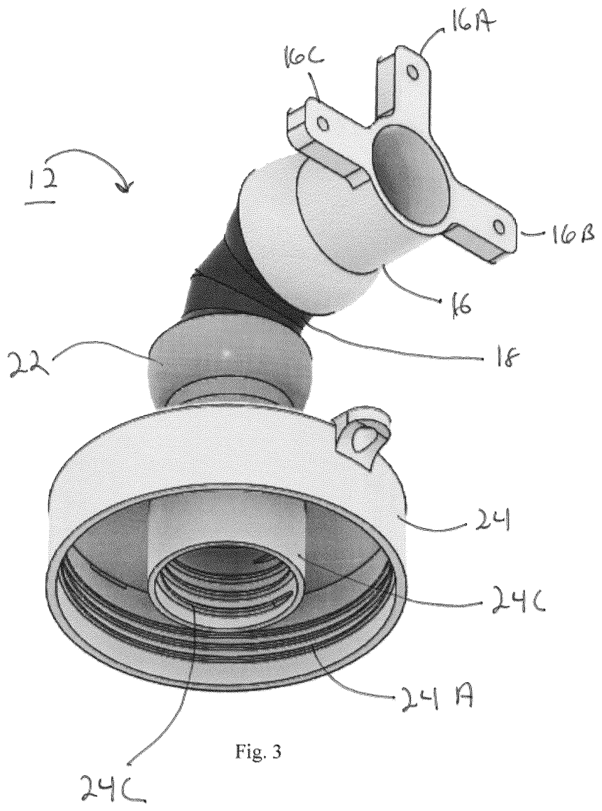

The cylindrical-shaped hollow cap 24, may, as shown in FIG. 3, include more than one set of threads (or other means) to receive and secure the catch basin 14. In the embodiment of FIG. 3, the larger diameter threads 24A may receive the catch basin 14 while the smaller diameter threads, 24C may receive a smaller receptacle, such as a disposable bottle (such as a water bottle). The cylindrical-shaped hollow cap 24 also includes a sliding door 20 which can be moved from an open to a closed position. In the open position, a carpenter bee is free to travel as it desires from the catch basin 14 to the funneling element 12. In the closed position however, the carpenter bee would be contained in catch basin 14. This option is especially useful when a user is moving the trap from one location to another. The cylindrical-shaped hollow cap 24 may optionally include extensions 24D and 24E which could be used to secure the cap to a substrate if desired.

Catch basin 14 includes a large cavity, one or more handles 28 and threads 30. The cavity is where a carpenter bee trapped within the insect trap 10 would generally be held. The catch basin also includes an outer surface 26 which may further contain an adhesive—put another way, it is sticky. The adhesive should be of sufficient strength to retain a carpenter bee that lands on the outer surface 26. In one embodiment, the adhesive may be present in discrete sheets affixed to the outer surface 26 such that if a first sheet becomes less adhesive than desired or is covered with insects, it could be removed (i.e., peeled away) exposing a new sheet. In another embodiment, the outer surface 26 may contain an adhesive along with filled, dark circles (or dots). The dark circles resemble carpenter bee holes which may attract carpenter bees and are, in one preferred embodiment, sized similarly to a carpenter bee hole. The handles 28 on the catch basin 14 allow a user to handle the catch basin 14 without contacting the adhesive.

Optionally, the trap 10 may include an attractant whether chemical, physical, auditory, visual or other that serves as an attractant to bees.

The insect trap 10 generally functions as follows. It is mounted over an existing, active, carpenter bee bore. Specifically, funneling element 12 is placed over the bore thus effectively trapping the carpenter bee. The trapped carpenter bee will be free to buzz and fly around which will attract more bees. Those attracted bees will come into contact with the adhesive outer surface 26 of the catch basin 14 and then become stuck thereon. After a few days, the catch basin 14 could be discarded and the insect trap 10 could be moved to a different active carpenter bee bore. Additionally, as described above, the cylindrical-shaped hollow cap 24 may receive a variety of different catch basins 14 and then the insect trap could be used for other types of insects.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

The terms “about” and “approximately” shall generally mean an acceptable degree of error or variation for the quantity measured given the nature or precision of the measurements. Typical, exemplary degrees of error or variation are within 20 percent (%), preferably within 10%, more preferably within 5%, and still more preferably within 1% of a given value or range of values. Numerical quantities given in this description are approximate unless stated otherwise, meaning that the term “about” or “approximately” can be inferred when not expressly stated. As used herein, the singular forms “a”, “an” and “the” are intended to include the plural forms as well, unless the context clearly indicates otherwise. Although particular embodiments of the present disclosure have been described, it is not intended that such references be construed as limitations upon the scope of this disclosure except as set forth in the claims.

I claim:

1. A device for trapping insects, comprising:
a. a funnel with opposing exits, with one exit of the funnel terminating into a ball and socket joint, the other exit terminating into an attachment;
b. a funnel extension;
c. a hollow cap adapter; and
d. a catch basin.

2. The device of claim 1, wherein the catch basin is disposable.

3. The device of claim 1, wherein the catch basin is clear or translucent.

4. The device of claim 1, wherein the catch basin is temporarily attached to the cylindrical-shaped hollow cap adapter.

5. The device of claim 1, wherein the catch basin's outer surface includes an adhesive.

6. The device of claim 1, comprising a sliding door positioned above the catch basin.

7. The device of claim 1, comprising a cylindrical-shaped hollow cap.

8. The device of claim 6, wherein the catch basin comprises handles on its exterior.

9. The device of claim 6, wherein the catch basin's outer surface includes an adhesive.

10. The device of claim 7, wherein the hollow cap includes extensions with apertures attached to the upper sides of the cylindrical-shaped hollow cap.

11. The device of claim 8, wherein the catch basin is disposable.

12. The device of claim 8, wherein the catch basin is clear or translucent.

13. A device for trapping insects, comprising:
a. a cylindrical-shaped hollow cap;
b. a catch basin; and
c. a sliding door positioned above the catch basin.

14. The device of claim 13, wherein the cylindrical-shaped hollow cap includes extensions with apertures attached to the upper sides of the cylindrical-shaped hollow cap.

15. The device of claim 13, wherein the catch basin is disposable.

16. The device of claim 13, wherein the catch basin is clear or translucent.

17. The device of claim 13, wherein the catch basin is temporarily attached to the cylindrical-shaped hollow cap adapter.

18. The device of claim 13, wherein the catch basin's outer surface includes an adhesive.

19. The device of claim 13, wherein the catch basin comprises handles on its exterior.
